(19) United States
(12) Patent Application Publication
(10) Pub. No.: US 2021/0097940 A1
(43) Pub. Date: Apr. 1, 2021

(54) Scanning Type Backlight Display Method and Scanning Type Backlight Display System Capable of Reducing a Motion Blur Effect and Enhancing Image Brightness

(71) Applicant: QISDA CORPORATION, Taoyuan CIty (TW)

(72) Inventor: Min-Jye Chen, Taoyuan City (TW)

(21) Appl. No.: 17/026,292

(22) Filed: Sep. 20, 2020

(30) Foreign Application Priority Data
Sep. 29, 2019 (CN) 201910933383.0

(51) Int. Cl. G09G 3/34

(52) U.S. Cl. CPC G09G 3/342; G09G 2320/0626; G09G 2310/0297

(57) ABSTRACT

A scanning type backlight display method includes partitioning at least one part of backlight devices of a display panel for generating a plurality of backlight device sets, selecting a backlight device from each backlight device set, and sequentially enabling a plurality of selected backlight devices. Time intervals of enabling a plurality of backlight devices of the each backlight device set are non-overlapped.

### BACKGROUND OF THE INVENTION

### 1. Field of the Invention

The present invention illustrates a scanning type backlight display method and a scanning type backlight display system, and more particularly, a scanning type backlight display method and a scanning type backlight display system capable of reducing a motion blur effect and enhancing image brightness.

### 2. Description of the Prior Art

Liquid crystal display (LCD) and organic light-emitting diode (OLED) display devices have been widely used for applying to multimedia products, mobile phones, personal digital assistants, computer monitors, or flat-screen TVs since they have advantages of low power consumption, no radiation, and slim bodies.

Conventional monitors use pulse width modulation (PWM) signals for driving backlight devices when images are displayed. The backlight devices are continuously turned on (i.e., as hold-type displays). Since the backlight devices are continuously turned on, a pixel refreshing process is visible, leading to unstable images and visual quality reduction. Particularly, when a displaying frequency requirement of the images is high or when dynamic images having high motion objects are displayed, a motion blur effect is prone to be generated, thereby reducing an image quality. Some advanced displays use cathode ray tubes for applying to the backlight devices. The backlight devices are driven according to pulse signals (i.e., as impulse-type displays). For example, the displays can drive the backlight devices by increasing N times of a frequency of the driving signals. N is a positive integer. Alternatively, the displays can enable the backlight devices during a blank interval of a vertical synchronization signal. However, although the hold-type displays and the impulse-type displays can reduce the motion blur effect, the image brightness may be insufficient. Further, image stability may be reduced.

### SUMMARY OF THE INVENTION

In an embodiment of the present invention, a scanning type backlight display method is disclosed. The scanning type backlight display method comprises partitioning at least one part of backlight devices of a display panel for generating a plurality of backlight device sets, selecting a backlight device from each backlight device set, and sequentially enabling a plurality of selected backlight devices. Time intervals of enabling a plurality of backlight devices of the each backlight device set are non-overlapped.

In another embodiment of the present invention, a scanning type backlight display system is disclosed. The scanning type backlight display system comprises a display panel, a backlight array, a backlight controller, and a processor. The display panel is configured to display an image. The backlight array is configured to generate a backlight signal to the display panel. The backlight controller is coupled to the backlight array and configured to control the backlight array. The processor is coupled to the display panel and the backlight controller and configured to receive an image signal and control the display panel and the backlight controller. After the processor receives the image signal, the processor partitions at least one part of backlight devices of backlight array for generating a plurality of backlight device sets. The processor controls the backlight controller for selecting a backlight device from each backlight device set. After the backlight device is selected from the each backlight device set, the processor controls the backlight controller for sequentially enabling a plurality of selected backlight devices. Time intervals of enabling a plurality of backlight devices of the each backlight device set are non-overlapped.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a scanning type backlight display system according to an embodiment of the present invention.

FIG. 2 is an illustration of waveforms of all backlight driving signals and a vertical synchronization signal of the scanning type backlight display system in FIG. 1.

FIG. 3 is an illustration of non-overlapped time intervals of enabling a plurality of backlight devices of each backlight device set of the scanning type backlight display system in FIG. 1.

FIG. 4 is an illustration of a time difference of enabling two adjacent backlight devices of the scanning type backlight display system in FIG. 1.

FIG. 5 is an illustration of a scanning type backlight display method performed by the scanning type backlight display system in FIG. 1.

### DETAILED DESCRIPTION

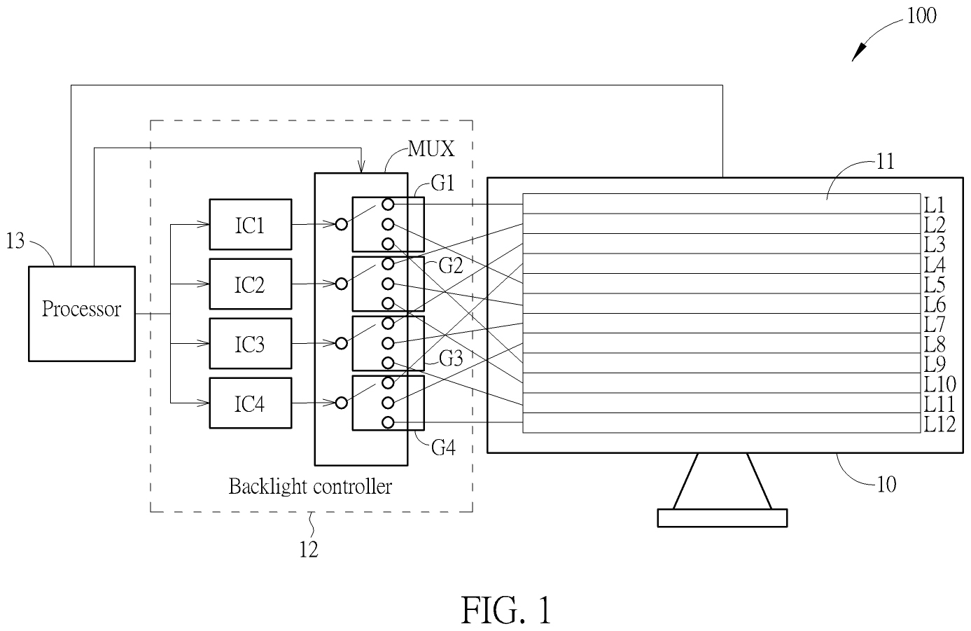

FIG. 1 is a block diagram of a scanning type backlight display system 100 according to an embodiment of the present invention. For simplicity, the scanning type backlight display system 100 is called as a “display system 100” hereafter. The display system 100 includes a display panel 10, a backlight array 11, a backlight controller 12, and a processor 13. The display panel 10 is used for displaying an image. The display panel 10 can be any display panel, such as a liquid crystal display (LCD) panel or an organic light emitting diode (OLED) display panel. The display panel 10 can include a plurality of pixels. The backlight array 11 is used for generating a backlight signal to the display panel 10. The backlight signal can be any reasonable visible light signal. The backlight array 11 can include a plurality of backlight devices L1 to L12. The backlight devices L1 to L12 can be a plurality of strip backlight devices vertically allocated on a range of the display panel 10. The backlight controller 12 is coupled to the backlight array 11 for controlling the backlight array 11. The processor 13 is coupled to the display panel 10 and the backlight controller 12 for receiving an image signal, and controlling the display panel 10 and the backlight controller 12. The image signal can be generated by any video signal source, such as a graphics card or a video player. After the processor 13 receives the image signal, the processor 13 partitions at least one part of backlight devices of the backlight array 11 for generating a plurality of backlight device sets (i.e., such as G1 to G4). The processor 13 can also partition at least one part of the backlight devices according to user's configurations. Further, the processor 13 controls the backlight controller 12 for selecting a backlight device from each backlight device set. After the backlight device is selected from the each backlight device set, the processor 13 controls the backlight controller 12 for sequentially enabling a plurality of selected backlight devices. Further, time intervals of enabling a plurality of backlight devices of the each backlight device set are non-overlapped.

In the display system 100, the backlight controller 12 can include a multiplexer MUX coupled to the backlight array 11 and a plurality of backlight driving circuits IC1 to IC4 coupled to the multiplexer MUX. However, the display system 100 is not limited to an amount of the backlight driving circuits IC1 to IC4. Further, the multiplexer MUX can include a plurality of switches for partitioning a plurality of backlight devices L1 to L12 of the backlight array 12. For example, in FIG. 1, the plurality of backlight devices L1 to L12 can be partitioned for generating a plurality of backlight device sets G1 to G4. Each backlight device set G1 to G4 can be controlled by a backlight driving circuit IC1 to IC4 through the multiplexer MUX. Further, the backlight driving circuit IC1 to IC4 can control the multiplexer MUX for executing a switching process to select the backlight device L1 to L12 from the each backlight device set G1 to G4. The backlight driving circuit IC1 to IC4 can drive the backlight device L1 to L12 after the backlight device L1 to L12 is selected. For example, in FIG. 1, a first backlight device set G1 includes a plurality of backlight devices L1, L5, and L9. A second backlight device set G2 includes a plurality of backlight devices L2, L6, and L10. A third backlight device set G3 includes a plurality of backlight devices L3, L7, and L11. A fourth backlight device set G4 includes a plurality of backlight devices L4, L8, and L12. Further, the plurality of backlight devices of the each backlight device set can be uniformly distributed within the range of the display panel 10. For example, the backlight devices L1, L5, and L9 (i.e., equally spaced allocation) of the first backlight device set G1 are uniformly distributed within the range of the display panel 10. The backlight devices L2, L6, and L10 (i.e., equally spaced allocation) of the second backlight device set G2 are uniformly distributed within the range of the display panel 10. Details of the scanning type backlight display method performed by the display system 100 are illustrated later.

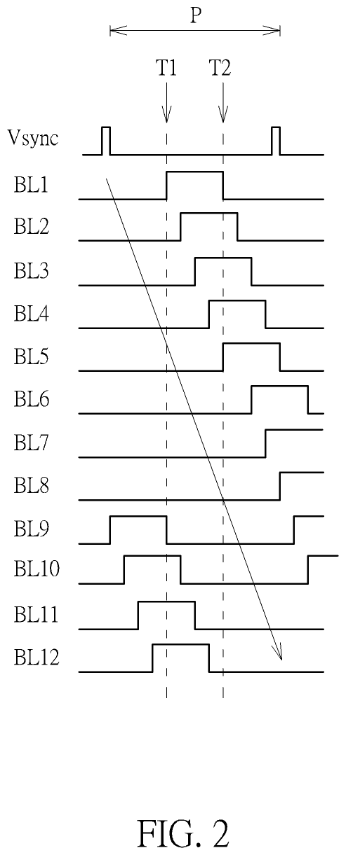

FIG. 2 is an illustration of waveforms of all backlight driving signals BL1 to BL12 and a vertical synchronization signal Vsync of the display system 100. The backlight driving signals BL1 to BL12 are used for respectively driving the backlight devices L1 to L12. As previously mentioned, the processor 13 can control the backlight controller 12 for selecting the backlight device from each backlight device set. After the backlight device is selected from the each backlight device set, the processor 13 controls the backlight controller 12 for sequentially enabling a plurality of selected backlight devices. For example, the processor 13 can select a first backlight device L1 from the first backlight device set G1 including the plurality of backlight devices L1, L5, and L9. Hereafter, the first backlight device L1 is called a first “selected” backlight device L1. The processor 13 can select a second backlight device L2 from the second backlight device set G2 including the plurality of backlight devices L2, L6, and L10. Hereafter, the second backlight device L2 is called a second “selected” backlight device L2, and so on. The processor 13 controls the backlight controller 12 for sequentially enabling the first selected backlight device L1 of the first backlight device set G1 and the second selected backlight device L2 of the second backlight device set G2. For example, in FIG. 2, at the time point T1, the first backlight driving signal BL1 is pulled high. The first selected backlight device L1 is turned on. Then, the second backlight driving signal BL2 is pulled high. The second selected backlight device L2 is turned on, and so on. Further, in FIG. 2, the first selected backlight device L1 of the first backlight device set G1 is enabled during a first time interval. The second selected backlight device L2 of the second backlight device set G2 is enabled during a second time interval. The first time interval and the second time interval are partially overlapped. When the first selected backlight device L1 of the first backlight device set G1 is enabled, remaining backlight devices L5 and L9 of the first backlight device set G1 are disabled. When the second selected backlight device L2 of the second backlight device set G2 is enabled, remaining backlight devices L6 and L10 of the second backlight device set G2 are disabled. In the display system 100, the backlight devices L1 to L12 are sequentially enabled. Further, at least two backlight devices are simultaneously enabled at any moment. For example, at a time point T2, according to waveforms of the backlight driving signal BL2 to the backlight driving signal BL4, the second selected backlight device L2, the third selected backlight device L3, and the fourth selected backlight device L4 are enabled. In other words, in the display system 100, since at least two backlight devices are turned on (enabled) at any moment, brightness of displayed images can be increased.

Further, in the display system 100, the processor 13 can generate a vertical synchronization signal Vsync. The vertical synchronization signal Vsync has a period P. The period P can be regarded as an image frame period. The period P of the vertical synchronization signal Vsync includes a pixel active interval and a blank interval. The plurality of pixels of the display panel 10 can be sequentially refreshed during the pixel active interval. Further, the processor 13 can control the backlight controller 12 for disabling a part of backlight devices of the backlight array 11 of the display panel 10 during the pixel active interval in order to reduce the motion blur effect. For example, when the plurality of pixels of the display panel 10 are sequentially refreshed in the direction indicated by an arrow in FIG. 2, the processor 13 can control the backlight controller 12 for sequentially disabling corresponding backlight devices. By doing so, since the pixel refreshing process is invisible, the display system 100 is capable of reducing the motion blur effect, leading to improving a visual quality. However, a pixel refreshing mode of the display system 100 can be any reasonable pixel refresh mode, such as a dot inversion mode, a column inversion mode, or a frame inversion mode. Any reasonable technology modification falls into the scope of the present invention.

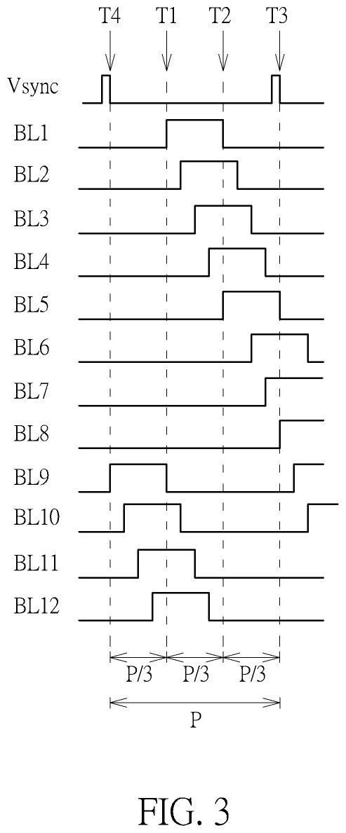

FIG. 3 is an illustration of non-overlapped time intervals of enabling the plurality of backlight devices of each backlight device set of the display system 100. As previously mentioned, the plurality of backlight devices of the each backlight device set can be uniformly distributed within the range of the display panel 10. In order to allocate uniformly distributed time intervals for enabling the backlight devices in each set of backlight devices during the period P of the vertical synchronization signal Vsync, time intervals of enabling the plurality of backlight devices of the each backlight device set are non-overlapped. For example, the first backlight device set G1 includes the plurality of backlight devices L1, L5, and L9. The processor 13 boosts power of a backlight driving signal BL1 during a time point T1 to a time point T2 for enabling the backlight device L1 (i.e., the selected backlight device L1). The processor 13 boosts power of a backlight driving signal BL5 during a time point T2 to a time point T3 for enabling the backlight device L5 (i.e., the selected backlight device L5). The processor 13 boosts power of a backlight driving signal BL9 during a time point T4 to a time point T1 for enabling the backlight device L9 (i.e., the selected backlight device L9). In other words, the backlight driving signal BL1 is pulled high during the time point T1 to the time point T2. The backlight driving signal BL5 is pulled high during the time point T2 to the time point T3. The backlight driving signal BL9 is pulled high during the time point T4 to the time point T1. Therefore, the plurality of backlight devices L1, L5, and L9 are enabled during different time intervals. In other words, when the first selected backlight device L1 of the first backlight device set G1 is enabled, remaining backlight devices L5 and L9 of the first backlight device set G1 are disabled. Similarly, when the second selected backlight device L2 of the second backlight device set G2 is enabled, remaining backlight devices L6 and L10 of the second backlight device set G2 are disabled. Generally, the time interval of enabling the each backlight device is equal to P/Q. P is the period of the vertical synchronization signal Vsync. The each backlight device set includes Q backlight devices. P is a positive integer greater than 0. Q is a positive integer greater than two. In FIG. 3, since each backlight device set includes three backlight devices (Q=3), a time interval of enabling each backlight device is equal to P/3.

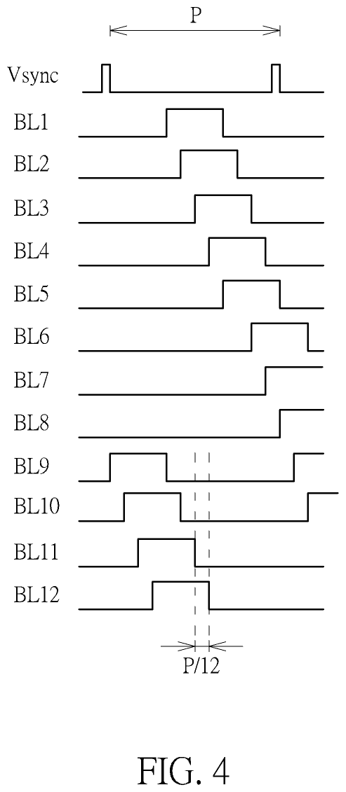

FIG. 4 is an illustration of a time difference of enabling two adjacent backlight devices of the display system 100. As previously mentioned, after the processor 13 generates the vertical synchronization signal Vsync, the processor 13 can set the time interval of enabling each backlight device according to the period of the vertical synchronization signal Vsync and the amount of the backlight devices of each backlight device set. Further, the processor 13 can set the time difference of enabling two adjacent backlight devices before the plurality of selected backlight devices are sequentially enabled, as illustrated below. In FIG. 4, in the display system 100, each selected backlight device is operated according to a corresponding backlight driving signal. Further, offsets (or say, delays) of the time intervals of boosting power of the backlight driving signals BL1 to BL12 are identical. In FIG. 4, during the period P of the vertical synchronization signal Vsync, 12 offsets of the time intervals of boosting the power of the backlight driving signals BL1 to BL12 are introduced. Therefore, the time difference of enabling two adjacent backlight devices is equal to P/12. Generally, the time difference of enabling the two adjacent backlight devices is equal to P/M. P is the period of the vertical synchronization signal. M is an amount of the backlight devices vertically allocated on the backlight array of the display panel. P is a positive integer greater than 0. M is a positive integer greater than two.

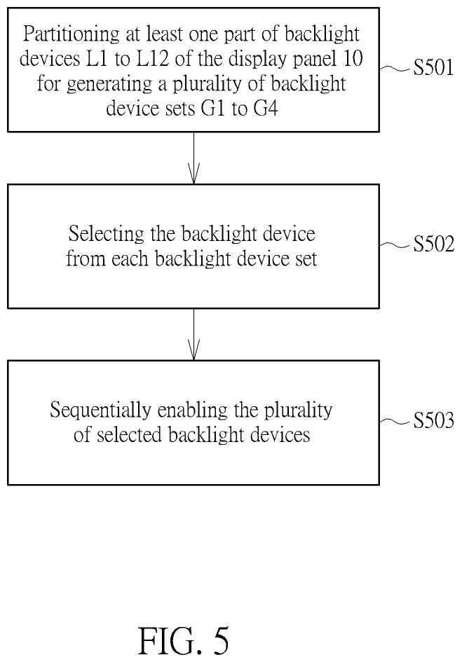

FIG. 5 is an illustration of a scanning type backlight display method performed by the display system 100. The scanning type backlight display method includes step S501 to step S503. Any reasonable technology modification falls into the scope of the present invention. Step S501 to step S503 are illustrated below.
step S501: partitioning at least one part of backlight devices L1 to L12 of the display panel 10 for generating a plurality of backlight device sets G1 to G4;
step S502: selecting the backlight device from each backlight device set;
step S503: sequentially enabling the plurality of selected backlight devices.

Details of steps S501 to S503 are illustrated previously. Thus, they are omitted here. A purpose of the display system 100 is to perform the scanning type backlight display method for reducing the motion blur effect of the displayed images without sacrificing image brightness. The display system 100 can partition the backlight devices and can sequentially enable some backlight devices by using the multiplexer MUX. Therefore, the display system 100 can perform the scanning type backlight display method with simple hardware. Further, the display system 100 is capable of reducing the motion blur effect and enhancing the brightness of the displayed images.

To sum up, the present invention illustrates a scanning type backlight display method and a scanning type backlight display method system. The scanning type backlight display method system includes a plurality of backlight devices vertically arranged within a range of a display panel. In order to avoid the motion blur effect, the backlight devices can be sequentially enabled. Further, since the scanning type backlight display system can enable at least two backlight devices at any moment, the brightness of the displayed image can be increased. Further, the scanning type backlight display system can partition the backlight devices into several backlight device sets and then select one backlight device from each backlight device set through a multiplexer. Therefore, the scanning type backlight display system can perform the scanning type backlight display method with simple hardware circuits. By doing so, the scanning type backlight display system is capable of reducing the motion blur effect and enhancing the brightness of the displayed images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scanning type backlight display method comprising:
partitioning at least one part of backlight devices of a display panel for generating a plurality of backlight device sets;
selecting a backlight device from each backlight device set; and
sequentially enabling a plurality of selected backlight devices;
wherein time intervals of enabling a plurality of backlight devices of the each backlight device set are non-overlapped.

2. The method of claim 1, wherein the plurality of backlight device sets comprise a first backlight device set and a second backlight device set, and sequentially enabling the plurality of selected backlight devices is sequentially enabling a first selected backlight device of the first backlight device set and a second selected backlight device of the second backlight device set.

3. The method of claim 2, wherein the first selected backlight device of the first backlight device set is enabled during a first time interval, the second selected backlight device of the second backlight device set is enabled during a second time interval, and the first time interval and the second time interval are partially overlapped.

4. The method of claim 2, wherein when the first selected backlight device of the first backlight device set is enabled, remaining backlight devices of the first backlight device set are disabled, and when the second selected backlight device of the second backlight device set is enabled, remaining backlight devices of the second backlight device set are disabled.

5. The method of claim 1, further comprising:
generating a vertical synchronization signal;
setting a time interval of enabling each backlight device according to a period of the vertical synchronization signal; and
setting a time difference of enabling two adjacent backlight devices before the plurality of selected backlight devices are sequentially enabled.

6. The method of claim 5, wherein the time difference of enabling the two adjacent backlight devices is equal to P/M, the time interval of enabling the each backlight device is equal to P/Q, the each backlight device set comprises Q backlight devices, Q is a positive integer greater than two, P is the period of the vertical synchronization signal, M is a count of the backlight devices vertically allocated on the display panel, P is a positive integer greater than 0, and M is a positive integer greater than two.

7. The method of claim 1, further comprising:
generating a vertical synchronization signal;
wherein sequentially enabling the plurality of selected backlight devices is sequentially enabling the plurality of selected backlight devices in a vertical pixel scanning direction of the display panel, a period of the vertical synchronization signal comprises a pixel active interval and a blank interval, a plurality of pixels of the display panel are sequentially refreshed during the pixel active interval, and a part of backlight devices of the display panel are disabled during the pixel active interval for reducing a motion blur effect.

8. The method of claim 1, wherein the each backlight device set is controlled by a backlight driving circuit, the backlight driving circuit is used for executing a switching process to select the backlight device from the each backlight device set, and the backlight driving circuit drives the backlight device after the backlight device is selected.

9. The method of claim 1, wherein the plurality of backlight devices of the each backlight device set are uniformly distributed within a range of the display panel, and the plurality of backlight devices of the each backlight device set are strip backlight devices vertically allocated on the display panel.

10. The method of claim 1, wherein a first backlight device selected from a first backlight set is enabled within a pixel active interval of a vertical synchronization signal, a timing difference is present between a starting time of enabling the first backlight device and a starting time of a period of the vertical synchronization signal, the backlight devices are sequentially allocated in a vertical pixel scanning direction of a displayed image, the first backlight device is switched according to the first backlight set, a second backlight device is switched according to a second backlight set, the second backlight device is enabled after the first backlight device is enabled, and another backlight device is selected from the first backlight set and is enabled after the period of the vertical synchronization signal elapses.

11. A scanning type backlight display system comprising:
a display panel configured to display an image;
a backlight array configured to generate a backlight signal to the display panel;
a backlight controller coupled to the backlight array and configured to control the backlight array; and
a processor coupled to the display panel and the backlight controller and configured to receive an image signal and control the display panel and the backlight controller;
wherein after the processor receives the image signal, the processor partitions at least one part of backlight devices of the backlight array for generating a plurality of backlight device sets, the processor controls the backlight controller for selecting a backlight device from each backlight device set, after the backlight device is selected from the each backlight device set, the processor controls the backlight controller for sequentially enabling a plurality of selected backlight devices, and time intervals of enabling a plurality of backlight devices of the each backlight device set are non-overlapped.

12. The system of claim 11, wherein the plurality of backlight device sets comprise a first backlight device set and a second backlight device set, and the processor controls the backlight controller for sequentially enabling a first selected backlight device of the first backlight device set and a second selected backlight device of the second backlight device set.

13. The system of claim 12, wherein the first selected backlight device of the first backlight device set is enabled during a first time interval, the second selected backlight device of the second backlight device set is enabled during a second time interval, and the first time interval and the second time interval are partially overlapped.

14. The system of claim 12, wherein when the first selected backlight device of the first backlight device set is enabled, remaining backlight devices of the first backlight device set are disabled, and when the second selected backlight device of the second backlight device set is enabled, remaining backlight devices of the second backlight device set are disabled.

15. The system of claim 11, wherein the processor generates a vertical synchronization signal, sets a time interval of enabling each backlight device according to a period of the vertical synchronization signal, and sets a time difference of enabling two adjacent backlight devices before the plurality of selected backlight devices are sequentially enabled.

16. The system of claim 15, wherein the time difference of enabling the two adjacent backlight devices is equal to P/M, the time interval of enabling the each backlight device is equal to P/Q, the each backlight device set comprises Q backlight devices, Q is a positive integer greater than two, P is the period of the vertical synchronization signal, M is a count of the backlight devices vertically allocated on the backlight array of the display panel, P is a positive integer greater than 0, and M is a positive integer greater than two.

17. The system of claim 11, wherein the processor controls the backlight controller for sequentially enabling the plurality of selected backlight devices in a vertical pixel scanning direction of the display panel, the processor generates a vertical synchronization signal, a period of the vertical synchronization signal comprises a pixel active interval and a blank interval, a plurality of pixels of the display panel are sequentially refreshed during the pixel active interval, and a part of backlight devices of the backlight array of the display panel are disabled during the pixel active interval for reducing a motion blur effect.

18. The system of claim 11, wherein the backlight controller comprises:
a multiplexer coupled to the backlight array; and
a plurality of backlight driving circuits coupled to the multiplexer;
wherein the each backlight device set is controlled by a backlight driving circuit, the backlight driving circuit controls the multiplexer for executing a switching process to select the backlight device from the each backlight device set, and the backlight driving circuit drives the backlight device after the backlight device is selected.

19. The system of claim 11, wherein the plurality of backlight devices of the each backlight device set are uniformly distributed within a range of the display panel, and the plurality of backlight devices of the each backlight device set are strip backlight devices vertically allocated on the display panel.

20. The system of claim 11, wherein a first backlight device selected from a first backlight set is enabled within a pixel active interval of a vertical synchronization signal, a timing difference is present between a starting time of enabling the first backlight device and a starting time of a period of the vertical synchronization signal, the backlight devices are sequentially allocated in a vertical pixel scanning direction of a displayed image, the first backlight device is switched according to the first backlight set, a second backlight device is switched according to a second backlight set, the second backlight device is enabled after the first backlight device is enabled, and another backlight device is selected from the first backlight set and is enabled after the period of the vertical synchronization signal elapses.
